(19) United States
(12) Patent Application Publication
(10) Pub. No.: US 2024/0392858 A1
(43) Pub. Date: Nov. 28, 2024

(54) Torsional Vibration Damper

(71) Applicant: Hasse & Wrede GmbH, Berlin (DE)

(72) Inventors: Michael STEIDL, Berlin (DE); Stephan BOHMEYER, Hoppegarten (DE); Norbert REINSPERGER, Hoppegarten (DE); Sebastian WILLEKE, Hoppegarten (DE)

(21) Appl. No.: 18/673,983

(22) Filed: May 24, 2024

(30) Foreign Application Priority Data
May 26, 2023 (DE) 10 2023 113 991.6

(51) Int. Cl. F16F 15/173

(52) U.S. Cl. CPC F16F 15/173; F16F 2222/08; F16F 2224/025; F16F 2230/30; F16F 2232/02; F16F 2238/04

(57) ABSTRACT

A torsional vibration damper has a hub part (primary mass) which can be fastened on a drive shaft of an engine and a flywheel ring (secondary mass) surrounding the hub part in the radially outer region. A gap filled with a fluid and one or more sealing devices are provided between the hub part and the flywheel ring, by which the escape of the fluid is to be prevented. The sealing device or the sealing devices have in each case a first ring connected to the hub part and in each case a second ring connected to the flywheel ring as well as in each case a sealing element made of a plastic material, which is arranged in each case on the one hand in a sealing manner between the first ring and the hub part and on the other hand with the second ring and the flywheel ring. The sealing element is arranged in a clamped manner between the interconnected components, i.e. the first or second ring and the respectively associated hub part or flywheel ring.

### CROSS REFERENCE TO RELATED APPLICATION

This application claims priority under 35 U.S.C. § 119 from German Patent Application No. 102023113991.6, filed May 26, 2023, the entire disclosure of which is herein expressly incorporated by reference.

### BACKGROUND AND SUMMARY

The present invention relates to a torsional vibration damper having a hub part (primary mass) which can be fastened on a drive shaft of an engine and a flywheel ring (secondary mass) surrounding the hub part in the radially outer region, wherein a gap filled with a fluid and one or more sealing devices are provided between the hub part and the flywheel ring, by which the escape of the fluid is to be prevented.

A generic torsional vibration damper is known from DE 10 2020 118 066 A1. GB 11 05 292 A and WO2018/019729 A1 are also cited for the technological background.

The generic torsional vibration dampers have an outwardly offset flywheel ring, which distinguishes their design from constructions in which the flywheel ring is completely encapsulated in a separate housing.

DE 10 2020 118 066 A1 then shows torsional vibration dampers with a hub part that can be attached to a drive shaft of a motor and a flywheel ring that surrounds the hub part in the radially outer area. A gap filled with a fluid and at least one sealing device is arranged between the hub part and the flywheel ring, by means of which the escape of the fluid is to be prevented.

The sealing devices each have a first ring that is tightly connected to the hub part, hereinafter referred to as the inner ring, and a second ring that is tightly connected to the flywheel ring, hereinafter referred to as the outer ring. The sealing device also has in each case a sealing element made of an elastomer, which is connected to the inner ring in a sealing manner on the one hand and to the outer ring on the other, in particular by vulcanization. The sealing element is welded at different heights.

The solution described above has proven itself in principle. However, the provision of the plastic-metal seal described above, in particular the elastomer-metal seal with the corresponding strength in the area of the torsional vibration damper, is associated with increased costs.

The present invention therefore addresses the object of creating a more cost-optimized variant with the advantages of DE 10 2020 119 066 A1.

The invention solves this object by providing a torsional vibration damper with the features of the independent claim(s).

A torsional vibration damper according to the invention is designed with a hub part, which can be attached to a drive shaft of an engine, as the primary mass and a flywheel ring, which surrounds the hub part in the radially outer area, as the secondary mass.

A gap filled with a fluid and one or more sealing devices are provided between the hub part and the flywheel ring to prevent the fluid from escaping. The sealing device or the sealing devices each have a first ring connected to the hub part and a second ring connected to the flywheel ring, as well as a sealing element made of a plastic, in particular an elastomer.

The sealing element is arranged in each case sealingly between the first ring and the hub part on the one hand and between the second ring and the flywheel ring on the other.

The sealing element is clamped between the interconnected components, i.e. the first or second ring and the respectively associated flywheel ring or hub part. The arrangement of the sealing element between the two aforementioned components refers in particular to an arrangement in a section that extends through the axis of rotation of the torsional vibration damper.

By clamping between the respective ring and the other component of the torsional vibration damper, a flush connection of the ring with the flywheel ring or the hub part can be achieved on the one hand and a very cost-effective, time-saving and sufficiently strong connection of the components can be made possible on the other hand.

Further advantageous embodiments are the subject matter of the dependent claims.

To improve the clamping effect, it is advantageous if the sealing element has an edge-side, preferably circumferential, material bead.

In the same way, it is also advantageous if the material bead lies in a groove, preferably a circumferential groove.

The groove can advantageously be arranged in the flywheel ring or hub part.

The first ring can be advantageously flush with the hub part. The second ring can be flush with the flywheel ring. In this case, the sealing element and the ring lie in a step of the hub part and/or the flywheel ring and are flush with the outside of the respective hub part or flywheel ring.

For better insertion of the material bead, the groove has a trapezoidal cross-sectional area, for example. Alternatively, the trapezoidal cross-section can form an undercut so that the material bead is held axially in the groove with respect to the axis of rotation of the torsional vibration damper.

The connection for clamping the sealing element can be formed in particular between the first ring and the hub part or between the second ring and the flywheel ring by one or more mechanical connectors, in particular by screwing.

Alternatively or in addition to the aforementioned variant, the connection can be formed in particular between the first ring and the hub part or between the second ring and the flywheel ring by means of a materially bonded connection, in particular welding.

The material bead can be ring-shaped for sealing on all sides and preferably with a circular or ovoid cross-section. This seal enables a wide-area contact on the corresponding sealing surface of the groove and the ring.

Alternatively, the material bead can be star-shaped, preferably X-shaped. This creates several sealing lips or sealing planes. For further optimized retention of the seal under the effect of radial tensile forces, it is advantageous if the shape of the material bead is complementary to the shape of the groove. For this purpose, the torsional vibration damper can in particular have a positive fit between the material bead and the groove, which is designed as an axial stop, in particular with an undercut.

The mechanical connectors can be advantageously designed as screws, fitting bolts, bushes, preferably slotted bushes, rivets and/or clamps. The connection can be made by screwing, by press-fitting or by other means.

Furthermore, the mechanical connectors can be inserted through an opening in the sealing element, in particular in the material bead. This is an opening that is made in the material of the annular sealing element.

Preferably, the mechanical connectors or the welding are arranged outside the sealing area with the sealing element, so that there is no material weakening of the sealing element.

For a long-lasting connection, it is advantageous if the welded connection is designed as a through-welded connection through the respective ring.

Alternatively or additionally, the welded joint can be designed as a surface weld in a transition area between the respective ring and the flywheel ring or the hub part.

Preferably, a high-temperature resistant elastomer, such as EPDM or silicone material, can be used as the elastomer between the respective first and second rings of a sealing device. “Silicone material” in the context of this document means a material that contains or is a synthetic polymer in which silicon atoms are linked via oxygen atoms.

The sealing element can particularly preferably consist of an inorganically filled silicone elastomer, wherein the proportion of inorganic material is at least 30%. This is particularly useful because the materials mentioned are also suitable in high temperature ranges.

In addition, the material has little influence on the service life of silicone oil. Conversely, the material is resistant to the silicone oil and swells only slightly.

Further according to the invention is a torsional vibration damper having a hub part (primary mass) which can be fastened on a drive shaft of an engine and a flywheel ring (secondary mass) surrounding the hub part in the radially outer region, wherein a gap filled with a fluid and one or more sealing devices are provided between the hub part and the flywheel ring, by means of which the escape of the fluid is to be prevented, wherein the sealing device or the sealing devices each have at least one sealing element made of a plastic, which is arranged in each case in a sealing manner on the hub part and on the flywheel ring, wherein the sealing element is connected to the respectively associated flywheel ring or hub part by positive fit.

As in the first variant of the invention described above, the connection between the sealing element and the flywheel ring or hub part is purely mechanical and, in particular, does not require any complex electroplating.

The sealing element and the flywheel ring or the hub part can advantageously have a mutually complementary groove and a material bead, which form the positive fit.

The positive fit between the material bead and the groove can be designed as an axial stop, in particular with an undercut.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic partial sectional view of a connecting region of a first and a second variant of a torsional vibration damper according to the invention; which can advantageously also be combined with one another.

FIG. 2 is a schematic partial sectional view of a connecting region of a third variant of a torsional vibration damper according to the invention;

FIG. 3 is a schematic partial sectional view of a connecting region of a fourth variant of a torsional vibration damper according to the invention;

FIG. 4 is a schematic partial sectional view of a connecting region of a fifth and a sixth variant of a torsional vibration damper according to the invention;

FIG. 5 is a schematic partial sectional view of a connecting region of a seventh variant of a torsional vibration damper according to the invention; and

FIG. 6 is a schematic partial sectional view of a torsional vibration damper according to the prior art.

### DETAILED DESCRIPTION OF THE DRAWINGS

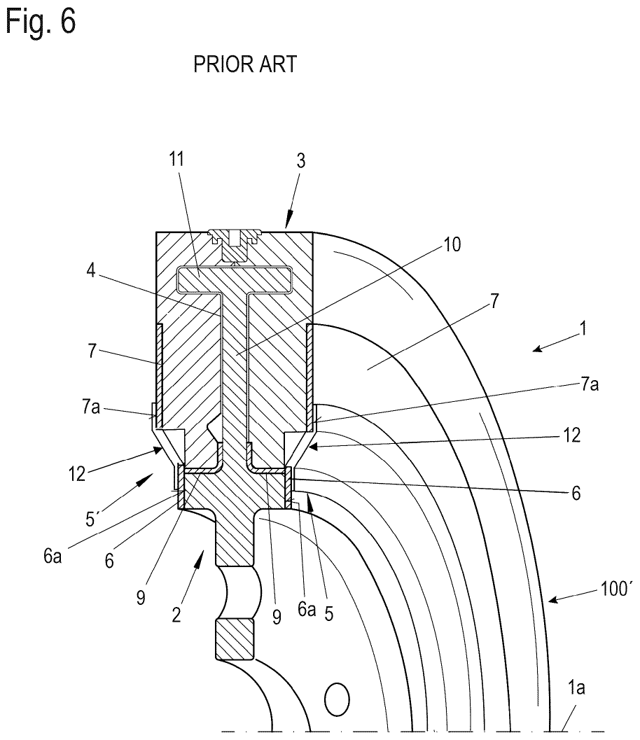

FIG. 6 shows a torsional vibration damper 1 from the prior art, which document DE 10 2020 118 066 A1, to which reference is made here, describes in detail the structure and function of the torsional vibration damper.

The torsional vibration damper having an axis of rotation 1a comprises a hub part 2 (primary mass) which can be attached to a drive shaft of an engine, a flywheel ring 3 (secondary mass) which surrounds the hub part 2 in the radially outer region, wherein a gap 4 is provided between the hub part 2 and the flywheel ring 3, which gap 4 is filled with a fluid, preferably a silicone oil, and sealing devices 5′ for sealing the gap 4 to the outside. This is an external flywheel ring 3.

Each sealing device 5′ has a first ring 6, which is tightly connected to the hub part 2, and a second ring 7, which is also tightly connected to the flywheel ring 3, as well as a sealing element 12 made of an elastomer or a TPE, which is connected to the first ring 6 in a sealing manner on the one hand and to the second ring 7 in a sealing manner on the other.

The rings 6, 7 are preferably made of metal and are firmly and tightly connected to the hub part 2 or the flywheel ring 3 by a suitable connection method, in particular screwing, welding, gluing, soldering or the like.

The respective sealing element 12 made of plastic, in particular elastomer or TPE, is connected to the two first and second rings 6, 7 in a circumferentially sealing manner. A plastic can also be an industrially modified natural product, although a silicone-based elastomer is preferred for the application due to its thermal stability.

The ring 6, ring 7 and the sealing element 12 form an assembly as a sealing device, which is also referred to as the cover 100′. The torsional vibration damper 1 has two covers 100′. The flywheel ring 3 is mounted here on plain bearings 9 in relation to the hub part 2, both radially and axially, whereby the size of the gap 4 is precisely defined.

The flywheel ring 3 preferably consists of two components in order to be able to mount this flywheel ring 3 on the hub part 2. All previously known design forms and others are possible.

In the exemplary embodiments shown, the hub part 2 is provided with a radially outwardly projecting flange 10, which is closed off in the outer edge area by a web 11 extending in the axial direction, which can extend to both sides of the flange 10, resulting in a T-shape, but can also extend to only one side of the flange 10, resulting in an L-shaped cross-section. Due to this geometry, the flywheel ring 3 is fixed relative to the hub part 2 both in the radial direction and in the axial direction, wherein, as already mentioned, the size of the circumferential gap 4 is always defined by the plain bearings 9.

The ring-shaped sealing element 12 made of plastic is simultaneously fixed to larger-surface, external axial and radial edge areas 6a, 7a of the rings 6 and 7. The edge areas 6a, 7a are thus fastening surfaces for the sealing element 12. This is described further below.

Each sealing device 5′ also consists of the first ring 6, which is tightly connected to the hub part 2, the second ring 7, which is also tightly connected to the flywheel ring 3, and the ring-shaped sealing element 12 made of plastic, which is connected to the first ring 6 in a sealing manner on the one hand and to the second ring 7 in a sealing manner on the other.

The first ring 6 and the second ring 7 of a respective sealing device 5′ do not overlap in the radial direction. The outer diameter of the first ring 6 is smaller than the inner diameter of the second ring 7.

The first and second rings 6, 7 of the respective sealing device 5′ are arranged here in axially spaced planes. This results in perfect and permanent sealing of the gap area.

In this way, covers 100′ for the torsional vibration damper 1 are formed, which each have the first ring 6, the second ring 7 and the sealing element 12.

The sealing element 12 is connected to the two first and second rings 6, 7 in a circumferentially sealing manner. In the prior art, this connection can be realized by a rubber-metal connection produced in particular during an elastomer crosslinking process.

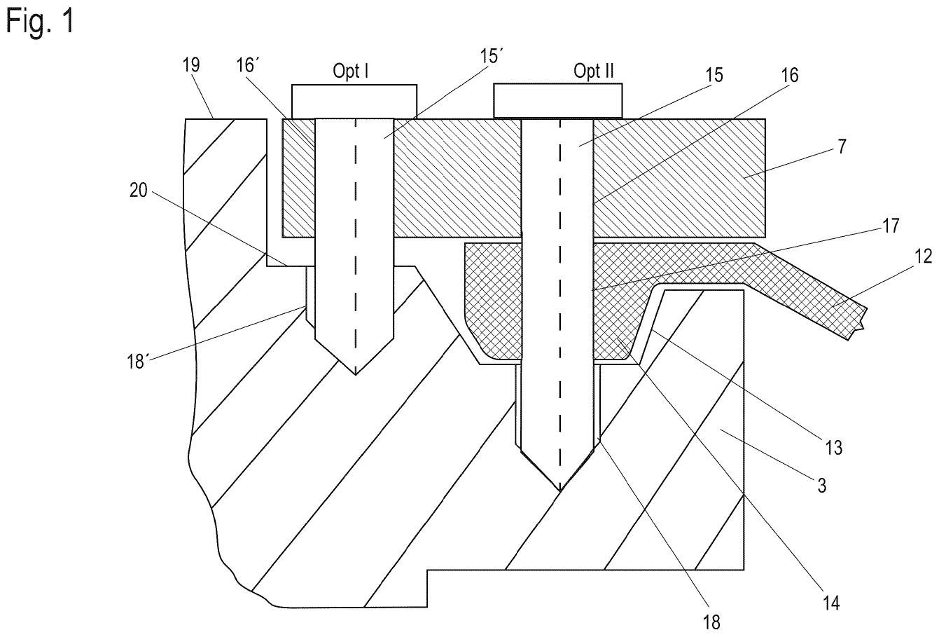

FIG. 1 shows a schematic sectional view of a multi-part cover 100 of a torsional vibration damper 1 according to the invention with two fastening variants of the sealing element 12 with the flywheel ring 3 in modification of FIG. 6. Apart from the connection of the sealing element 12 to the hub part 2 or to the flywheel ring 3 by means of the rings 6 and 7, the other components of the torsional vibration damper 1 of FIG. 6 can be adopted identically.

FIG. 1 shows two variants Opt. 1 and Opt. 2 of the fixing of the sealing element 12 on the flywheel ring 3, which can also be advantageously combined with one another. In both variants, the flywheel ring 3 is stepped so that a contact area 20 with the ring 7 is recessed relative to an outer side 19 of the flywheel ring 3 and is preferably arranged parallel to it.

In addition to the contact area 20, the graduation has a preferably circumferential groove 13, into which a material bead 14 of the sealing element 12 can be inserted at the edge. The sealing element 12 is clamped or held in a clamping manner in the groove 13 of the flywheel ring 3 via the material bead. The graduation has a screw channel 18, 18′ for accommodating a screw thread of a screw 15, 15′.

The outer ring 7 covers the contact area 20 and the groove 13 and thus clamps the sealing element 12. For this purpose, the ring 7 has screw bushings 16, 16′ with or without threads. The screw head of the screw 15, 15′ can also lie in a recess (not shown) in the ring 7 so that the screw 15, 15′ is flush with the outside 19 of the flywheel ring 3 and/or the outer ring 7.

The groove 13 is preferably trapezoidal in cross-section, so that the material of the material bead 14 is better distributed in the groove by the contact pressure of the ring 7 during screwing.

It is understood that several screws 15, 15′ are arranged circumferentially distributed on the outer ring 7.

The same arrangement results for the connection of the sealing element 12 to the hub part 2 by screwing the inner ring 6 to the hub part 2 and thereby clamping a material bead within a groove, preferably a circumferential groove, in the hub part 2. The material bead can advantageously be of the same shape as the material bead 12.

In the first variant Opt. 1, the ring 7 is screwed to the flywheel ring 3 outside the material of the sealing element 12.

In the second variant Opt. 2, the ring 7 is screwed to the flywheel ring 3 through the material of the sealing element 12. The sealing element 12, preferably the material bead 14, has a screw passage 17 so that the material bead, in addition to clamping, also extends the material of the mechanical connector through the material of the sealing element 12.

Instead of screwing the sealing element 12 to the hub part 2 and/or the flywheel ring 3 using corresponding screws, other forms of mechanical connectors, preferably pin-shaped connectors, particularly preferably fitting bolts, bushes, preferably slotted bushes, rivets and/or clamps, can also be used to create a corresponding connection.

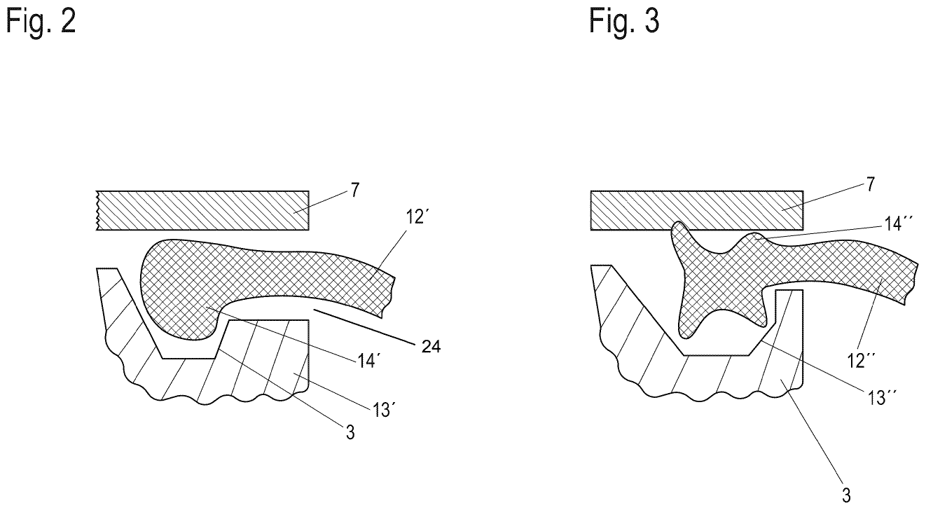

FIGS. 2 and 3 show different shapes of the material bead 14′ and 14″ of a sealing element 12′ and 12″ according to the invention in a variation of the variant of FIG. 1. The sealing element can also be fixed by a screw connection or by other mechanical connectors, as in FIG. 1.

In FIG. 2, the material bead 14′ is also located in a groove 13′, preferably a groove running around the outer ring 7, particularly preferably with a trapezoidal cross-section. A material bead in the form of an O-ring with a circular, essentially circular or ovoid cross-section is located in the groove 13′.

The material bead 14″ in FIG. 3 has a star-shaped cross-section. The star shape can be a regular or irregular star shape. The prongs of the star enable better deformation of the plastic material, preferably the elastomer material, and contact of the sealing element with the ring 7 and the groove 13″ of the flywheel ring 3 in the area of the material bead 14″ with the walls in the form of sealing lips. This results in a wider sealing surface and a multi-stage seal. The star shape in FIG. 2 has the particularly preferred shape of the letter X.

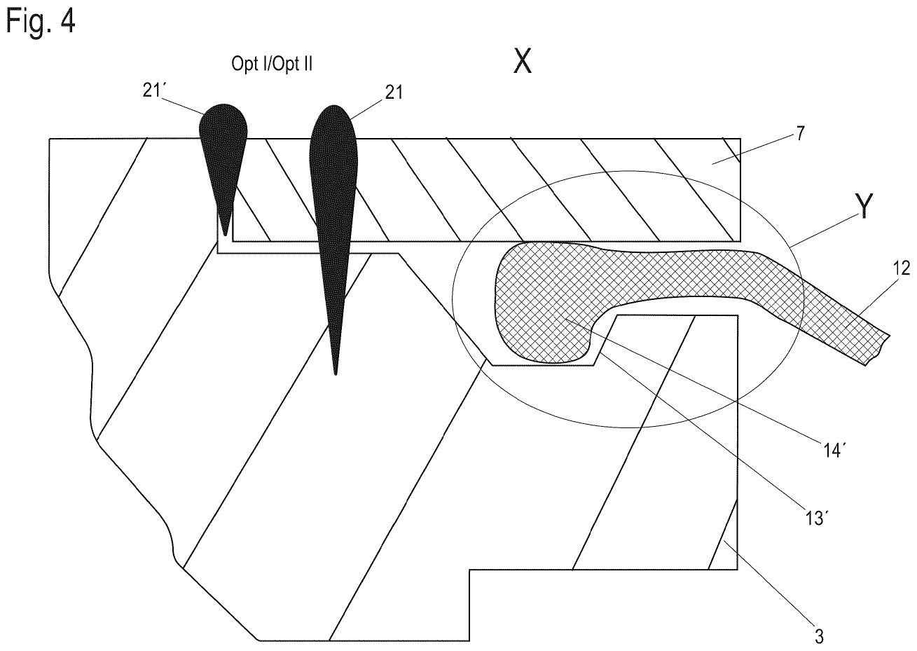

FIG. 4 shows an alternative connection between the outer ring 7 and the flywheel ring 3, which can alternatively or additionally also be arranged between the inner ring 6 and the hub part 2, in each case clamping the sealing element 12 of a torsional vibration damper according to the invention.

As an alternative to the connection by mechanical connectors, the connection is made by a material connection in the form of a welded connection. Welding can take place in a transition area between the outer ring 7 and the flywheel ring 3 by means of a surface weld seam 21′.

Alternatively or additionally, the welding between ring 7 and the flywheel ring 3 can be carried out by means of a through-welded weld seam 21. Both weld seams 21, 21′ are preferably arranged outside the groove 14′.

The alternative or mutually combinable welded joints Opt. 1 and Opt. 2 of FIG. 4 can also be realized with the other material bead geometries. The welded joints can be arranged circumferentially or less preferably as spot welds. The circumferential material weld protects the sealing area of the material bead from fluid penetration from the outside. The material weld forms an additional sealing layer to the seal created by the material bead.

The embodiment variants shown in the preceding variants also have a passage 24, which is arranged adjacent to the respective groove 13-13″ and is designed as a gap between the respective ring 6 or 7 and the hub part 2 or the flywheel ring 3, in which an adjacent region of the material bead 14-14″ of the sealing element 12-12″ is arranged. The gap width of this passage is greater than the extension of the sealing element 12-12″ within the gap, so that the sealing element 12-12″ has play in the area of the gap and is consequently arranged therein without load. As a result, the mounting of the sealing element is not overdetermined and material stresses are avoided.

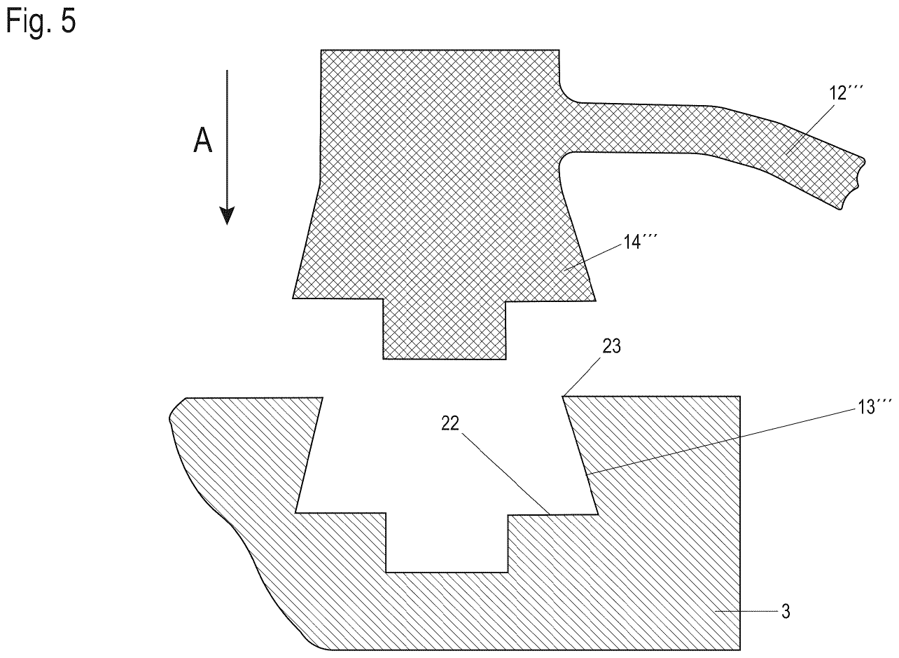

FIG. 5 shows a further variant of a material bead 14′″ of a sealing element 12″ in a torsional vibration damper according to the invention. The material bead 14″ has a shape complementary to the groove 13″. The groove 13″ has an opening 23 and a widening that tapers towards the groove base 22, so that the groove cross-section widens from the opening 23 towards the groove base 22. This is referred to as an undercut in the context of the present application.

The complementary shape between the material bead 14″ and groove 13″ results in a positive fit when the two areas are connected, with both elements locking against each other in the opposite direction to the insertion direction A. This facilitates pre-assembly and positioning of the sealing element. Furthermore, the retention of the sealing element 12″ is improved in the event of radial tension or pressure. In this case, the sealing element 12″ can be attached to the flywheel ring 3 and/or the hub part 2 exclusively by means of the positive fit, without the need for additional clamping, in order to ensure particularly quick and easy assembly. This means that both the outer ring 7 and the inner ring 6 can be advantageously omitted in this variant of FIG. 5. The material of the sealing element 12″ can correspond to the material of the previous embodiment variants.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 Torsional vibration damper
1a Axis of rotation
2 Hub part
3 Flywheel
4 Gap
5′ Scaling device
6 Ring
6a Edge area
7 Ring
7a Edge area
9 Plain bearing
10 Flange
11 Web
12, 12′, 12″, 12″ Sealing element
13, 13′, 13″, 13′″ Groove
14, 14′, 14″, 14″ Material bead
15, 15′ Mechanical connectors
16, 16′ Screw bushing
17 Screw bushing
18, 18′ Screw channel
19 Outside
20 Contact area
21,21′ Weld seam
22 Groove base
23 Opening
24 Passage
100 Cover

What is claimed is:

1. A torsional vibration damper, comprising:
a hub part as a primary mass which is fastenable on a drive shaft of an engine;
a flywheel ring as a secondary mass surrounding the hub part in a radially outer region; and
a gap filled with a fluid and one or more sealing devices provided between the hub part and the flywheel ring, by which an escape of the fluid is to be prevented, wherein
the sealing device or the sealing devices have, in each case, a first ring connected to the hub part and, in each case, a second ring connected to the flywheel ring as well as, in each case, a sealing element made of a plastic material, which is arranged in each case on the one hand in a sealing manner between the first ring and the hub part and on the other hand between the second ring and the flywheel ring, and
the sealing element is arranged in a clamped manner between interconnected components of the first or second ring and the respectively associated hub part or flywheel ring.

2. The torsional vibration damper according to claim 1, wherein
the sealing element has a material bead on an edge.

3. The torsional vibration damper according to claim 2, wherein
the material bead lies in a circumferential groove.

4. The torsional vibration damper according to claim 3, wherein
the groove is arranged in the flywheel ring or hub part, or
one groove is arranged in each of the flywheel ring and in the hub part.

5. The torsional vibration damper according to claim 1, wherein the first ring is flush with the hub part and/or the second ring is flush with the flywheel ring.

6. The torsional vibration damper according to claim 3, wherein the groove has a trapezoidal cross-sectional area.

7. The torsional vibration damper according to claim 1, wherein
the connection between the first ring and the hub part or between the second ring and the flywheel ring is made by one or more mechanical connectors.

8. The torsional vibration damper according to claim 1, wherein
the connection between the first ring and the hub part or between the second ring and the flywheel ring is made by material bonding.

9. The torsional vibration damper according to claim 2, wherein
the material bead is annular and has a circular or ovoid cross-section.

10. The torsional vibration damper according to claim 2, wherein
the material bead is star-shaped or X-shaped.

11. The torsional vibration damper according to claim 3, wherein a shape of the material bead is complementary to a shape of the groove.

12. The torsional vibration damper according to claim 7, wherein
the mechanical connectors comprise screws, fitting bolts, bushes, slotted bushes, rivets and/or clamps.

13. The torsional vibration damper according to claim 12, wherein
the mechanical connectors is/are passed through an opening in the sealing element.

14. The torsional vibration damper according to claim 1, wherein
the connection takes place outside the sealing area with the sealing element.

15. The torsional vibration damper according to claim 8, wherein
the material bonding is a welded connection designed as a through-welded connection through the respective ring.

16. The torsional vibration damper according to claim 8, wherein
the material bonding is a welded joint designed as a surface weld in a transition region between the respective ring and the flywheel ring or the hub part.

17. The torsional vibration damper according to claim 1, wherein
the sealing element comprises an elastomer, EPDM, or silicone material.

18. The torsional vibration damper according to claim 1, wherein
the torsional vibration damper has a passage adjacent to the groove, and
a gap width of the passage is greater than an extension of the sealing element within the passage.

19. A torsional vibration damper, comprising:
a hub part as a primary mass which is fastenable on a drive shaft of an engine;
a flywheel ring as a secondary mass surrounding the hub part in a radially outer region; and
a gap filled with a fluid and one or more sealing devices provided between the hub part and the flywheel ring, by which an escape of the fluid is to be prevented, wherein
the sealing device or the sealing devices have, in each case, at least one sealing element made of a plastic material, which is arranged, in each case, in a sealing manner on the hub part and on the flywheel ring, and
the sealing element is connected to the respectively associated flywheel ring or hub part by a positive fit.

20. The torsional vibration damper according to claim 19, wherein
the sealing element and the flywheel ring or the hub part each have a mutually complementary groove and a material bead, which form the positive fit.

21. The torsional vibration damper according to claim 19, wherein the positive fit between the material bead and the groove is configured as an axial stop with an undercut.
